(19) United States
(12) Patent Application Publication
(10) Pub. No.: US 2025/0024510 A1
(43) Pub. Date: Jan. 16, 2025

(54) METHODS AND APPARATUSES OF A MRO MECHANISM FOR UL COVERAGE ENHANCEMENT AND NETWORK SLICING PROCEDURES

(71) Applicant: LENOVO (BEIJING) LIMITED, Beijing (CN)

(72) Inventors: Lianhai Wu, Beijing (CN); Mingzeng Dai, Shanghai (CN); Le Yan, Shanghai (CN); Congchi Zhang, Shanghai (CN); Yibin Zhuo, Shanghai (CN)

(21) Appl. No.: 18/712,819

(22) PCT Filed: Nov. 23, 2021
(86) PCT No.: PCT/CN2021/132460

§ 371 Date: May 23, 2024

(51) Int. Cl. H04W 74/0833; H04W 36/30; H04W 76/27

(52) U.S. Cl. CPC H04W 74/0833; H04W 36/305; H04W 76/27

(57) ABSTRACT

Embodiments of the present application relate to methods and apparatuses of a mobility robustness optimization (MRO) mechanism for uplink (UL) coverage enhancement (CE) and network slicing procedures. According to an embodiment of the present application, a user equipment (UE) includes a processor and a transceiver coupled to the processor; and the processor is configured: to receive, via the transceiver from a network node, configuration information regarding at least one of a network slicing operation or an uplink (UL) transmission repetition operation; to perform a UL data transmission procedure or a random access channel (RACH) procedure based on the configuration information; and to transmit, via the transceiver to a serving cell, assistant information related to a failure of the UL data transmission procedure or a random access problem of the RACH procedure, wherein the assistant information is associated with at least one of the network slicing operation or the UL transmission repetition operation.

### TECHNICAL FIELD

Embodiments of the present application generally relate to wireless communication technology, in particular to methods and apparatuses of a mobility robustness optimization (MRO) mechanism for uplink (UL) coverage enhancement (CE) and/or network slicing procedures.

### BACKGROUND

A base station (BS) can have some cells (or areas) to provide communication service. When a user equipment (UE) moves from a serving cell of a source BS to a target cell of a target BS, a handover procedure is performed.

When a radio link failure (RLF) or a handover (HO) failure occurs for a UE, the UE may perform a radio resource control (RRC) re-establishment procedure. The UE may access a cell by a successful RRC re-establishment procedure. The accessed network will request UE information including a RLF report of the UE, such that the network can optimize the mobility problem based on the UE information from the UE. Accordingly, the UE will transmit a failure report to the network.

3rd Generation Partnership Project (3GPP) 5G networks are expected to increase network throughput, coverage, and robustness and reduce latency and power consumption. With the development of 3GPP 5G networks, various aspects need to be studied and developed to perfect the 5G technology. Currently, details regarding a MRO mechanism for UL CE and/or network slicing procedures have not been discussed in 3GPP 5G technology yet.

### SUMMARY

Some embodiments of the present application also provide a UE. The UE includes a processor and a transceiver coupled to the processor; and the processor is configured: to receive, via the transceiver from a network node, configuration information regarding at least one of a network slicing operation or an uplink (UL) transmission repetition operation; to perform a UL data transmission procedure or a random access channel (RACH) procedure based on the configuration information; and to transmit, via the transceiver to a serving cell, assistant information related to a failure of the UL data transmission procedure or a random access problem of the RACH procedure, wherein the assistant information is associated with at least one of the network slicing operation or the UL transmission repetition operation.

Some embodiments of the present application provide a method, which may be performed by a UE. The method includes: receiving, from a network node, configuration information regarding at least one of a network slicing operation or an UL transmission repetition operation; performing a UL data transmission procedure or a RACH procedure based on the configuration information; and transmitting, to a serving cell, assistant information related to a failure of the UL data transmission procedure or a random access problem of the RACH procedure, wherein the assistant information is associated with at least one of the network slicing operation or the UL transmission repetition operation.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned method performed by a UE.

Some embodiments of the present application also provide a source network node (e.g., a source BS). The network node includes a processor and a transceiver coupled to the processor; and the processor is configured: to transmit, via the transceiver to a UE, configuration information regarding at least one of a network slicing operation or an UL transmission repetition operation; and to receive, via the transceiver from a target network node, assistant information related to a failure of a UL data transmission procedure or a random access problem of a RACH procedure, wherein the assistant information is associated with at least one of the network slicing operation or the UL transmission repetition operation.

Some embodiments of the present application provide a method, which may be performed by a source network node (e.g., a source BS). The method includes: transmitting, to a UE, configuration information regarding at least one of a network slicing operation or an UL transmission repetition operation; and receiving, from a target network node, assistant information related to a failure of a UL data transmission procedure or a random access problem of a RACH procedure, wherein the assistant information is associated with at least one of the network slicing operation or the UL transmission repetition operation.

Some embodiments of the present application also provide a target network node (e.g., a target BS). The network node includes a processor and a transceiver coupled to the processor; and the processor is configured: to receive, via the transceiver from a UE, assistant information related to a failure of an UL data transmission procedure or a random access problem of a RACH procedure, wherein the assistant information is associated with at least one of a network slicing operation or a UL transmission repetition operation; and to transmit the assistant information via the transceiver to a source network node.

Some embodiments of the present application provide a method, which may be performed by a target network node (e.g., a target BS). The method includes: receiving, from a UE, assistant information related to a failure of an UL data transmission procedure or a random access problem of a RACH procedure, wherein the assistant information is associated with at least one of a network slicing operation or a UL transmission repetition operation; and transmitting the assistant information to a source network node.

Some embodiments of the present application provide an apparatus. The apparatus includes: a non-transitory computer-readable medium having stored thereon computer-executable instructions, a receiving circuitry; a transmitting circuitry; and a processor coupled to the non-transitory computer-readable medium, the receiving circuitry and the transmitting circuitry, wherein the computer-executable instructions cause the processor to implement the abovementioned methods performed by a network node (e.g., a source BS or a target BS).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application;

FIG. 2 illustrates an exemplary UE information procedure in accordance with some embodiments of the present application;

FIG. 3 illustrates an exemplary failure indication procedure in accordance with some embodiments of the present application;

FIG. 4 illustrates an exemplary access and mobility indication procedure in accordance with some embodiments of the present application;

FIG. 5 illustrates an exemplary block diagram of an apparatus according to some embodiments of the present application;

FIG. 6 illustrates an exemplary flow chart of a method for transmitting assistant information according to some embodiments of the present application;

FIG. 7 illustrates an exemplary flow chart of a method for receiving assistant information according to some embodiments of the present application; and

FIG. 8 illustrates a further exemplary flow chart of receiving assistant information according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd Generation Partnership Project (3GPP) LTE and LTE advanced, 3GPP 5G NR, 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

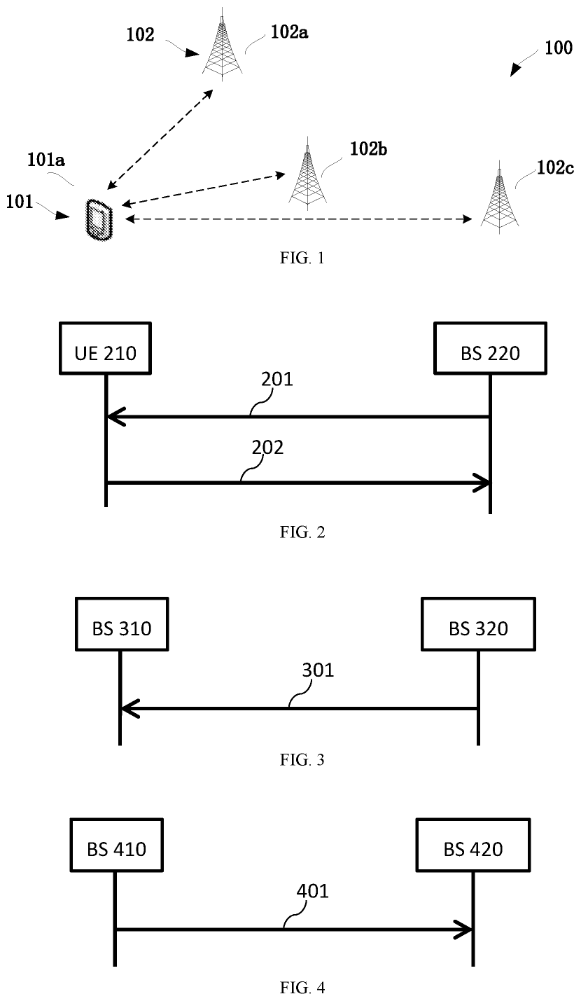

FIG. 1 illustrates a schematic diagram of a wireless communication system in accordance with some embodiments of the present application.

As illustrated and shown in FIG. 1, a wireless communication system 100 includes at least one user equipment (UE) 101 and at least one base station (BS) 102. In particular, the wireless communication system 100 includes one UE 101 (e.g., UE 101a) and three BSs 102 (e.g., BS 102a, BS 102b, and BS 102c) for illustrative purpose. Although a specific number of UEs 101 and BSs 102 are depicted in FIG. 1, it is contemplated that any number of UEs 101 and BSs 102 may be included in the wireless communication system 100.

UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), internet of things (IoT) devices, or the like. According to some embodiments of the present application, UE(s) 101 may include a portable wireless communication device, a smart phone, a cellular telephone, a flip phone, a device having a subscriber identity module, a personal computer, a selective call receiver, or any other device that is capable of transmitting and receiving communication signals on a wireless network. In some embodiments of the present application, UE(s) 101 includes wearable devices, such as smart watches, fitness bands, optical head-mounted displays, or the like. Moreover, UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. UE(s) 101 may communicate directly with BSs 102 via uplink (UL) communication signals.

In some embodiments of the present application, each of UE(s) 101 may be deployed an IoT application, an eMBB application and/or an URLLC application. It is contemplated that the specific type of application(s) deployed in UE(s) 101 may be varied and not limited.

BS(s) 102 may be distributed over a geographic region. In certain embodiments of the present application, each of BS(s) 102 may also be referred to as an access point, an access terminal, a base, a base unit, a macro cell, a Node-B, an evolved Node B (eNB), a gNB, a next generation-radio access network (NG-RAN) node, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of transmitting and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high altitude platform network, and/or other communications networks.

In some embodiments of the present application, the wireless communication system 100 is compatible with the 5G of the 3GPP protocol, wherein BS(s) 102 transmit data using an OFDM modulation scheme on the downlink (DL) and UE(s) 101 transmit data on the UL using a single-carrier frequency division multiple access (SC-FDMA) or OFDM scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 802.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of present application, BS(s) 102 may communicate with UE(s) 101 using the 3GPP 5G protocols.

Each BS(s) 102 may include one or more cells. Each UE(s) 101 may perform a cell section procedure between different cell(s) of different BS(s). Each UE(s) 101 may handover from a serving cell of a source BS to a target cell of a target BS. For example, in the wireless communication system 100 as illustrated and shown in FIG. 1, BS 102a may function as a source BS, and each of BS 102b and BS 102c may function as a target BS. If there is a handover need, UE 101a as illustrated and shown in FIG. 1 may perform a handover procedure from a serving cell of BS 102a to a target cell of BS 102b or a target cell of BS 102c, which depends a result of a cell selection procedure.

FIG. 2 illustrates an exemplary UE information procedure in accordance with some embodiments of the present application. The embodiments of FIG. 2 show a procedure of a UE (e.g., UE 210) communicating with a BS (e.g., BS 220). In some examples, UE 210 may function as UE 101a in FIG. 1. BS 220 may function as BS 102a, BS 102b, or BS 102c in FIG. 1.

As shown in FIG. 2, in operation 201, BS 220 (e.g., BS 102a as illustrated and shown in FIG. 1) transmits UEInformationRequest message to UE 210 (e.g., UE 101a as illustrated and shown in FIG. 1). BS 220 may be a source BS which controls a serving cell of UE 210. In operation 202, US 210 transmits UEInformationResponse message including a RLF report to BS 220. BS 220 can optimize a mobility problem based on the response transmitted from UE 210.

In a 3GPP 5G system, a failure indication procedure may be initiated after a UE attempts to re-establish the radio link connection at NG-RAN node B (e.g., BS 320 in FIG. 3) after a failure at NG-RAN node A (e.g., BS 310 in FIG. 3). NG-RAN node B (e.g., BS 320 in FIG. 3) may initiate a failure indication procedure towards multiple NG-RAN nodes if they control cells which use a physical cell identifier (PCI) signaled by the UE during the RRC re-establishment procedure. A failure indication may also be sent to the node last serving the UE when the NG-RAN node fetches the RLF report from the UE. A specific example of a failure indication procedure is described in FIG. 3.

The purpose of the failure indication procedure is to transfer information regarding RRC re-establishment attempts, or received RLF reports, between NG-RAN nodes. The signaling takes place from the NG-RAN node at which a re-establishment attempt is made, or a RLF report is received, to an NG-RAN node to which the UE concerned may have previously been attached prior to the connection failure. This may aid the detection of a RLF case or a HO failure case.

FIG. 3 illustrates an exemplary failure indication procedure in accordance with some embodiments of the present application. The embodiments of FIG. 3 show a procedure of one BS (e.g., BS 310) communicating with another BS (e.g., BS 320). In some examples, BS 310 or BS 320 may function as BS 102a, BS 102b, or BS 102c in FIG. 1.

As shown in FIG. 3, in operation 301, BS 320 transmits a failure indication message to BS 310. BS 310 is a source BS which controls the original serving cell of a UE (e.g., UE 101a as illustrated and shown in FIG. 1). BS 320 is a target BS or a new BS which controls a target cell or a conditional handover (CHO) candidate cell of the UE. The failure indication message may be transmitted by Xn interface or X2 interface. For example, the failure indication message includes a container of a RLF report. The container of the RLF report may be transmitted by Xn interface or X2 interface.

In a 3GPP 5G system, an access and mobility indication procedure may be initiated after a successful random access operation of NG-RAN nodes. The purpose of the access and mobility indication procedure is to transfer access and mobility related information between NG-RAN nodes via Xn interface. A specific example of a failure indication procedure is described in FIG. 4.

FIG. 4 illustrates an exemplary access and mobility indication procedure in accordance with some embodiments of the present application. The embodiments of FIG. 4 show a procedure of one BS (e.g., BS 410) communicating with another BS (e.g., BS 420). In some examples, BS 410 or BS 420 may function as BS 102a, BS 102b, or BS 102c in FIG. 1.

As shown in FIG. 4, in operation 401, BS 410 transmits an access and mobility indication message to BS 420. BS 410 initiates the access and mobility indication procedure by sending the access and mobility indication message to BS 420. The access and mobility indication message may be transmitted by Xn interface or X2 interface. For example, the access and mobility indication message includes a container of a RA-report list from a UE. RA-Report List is defined in 3GPP TS38.331. The container of the RA-report may be transmitted by Xn interface or X2 interface.

In general, coverage is one of key factors that an operator considers when commercializing cellular communication networks due to its direct impact on service quality. Compared to LTE, 5G new radio (NR) is designed to operate at much higher frequencies such as 28 GHz or 39 GHz in FR2. Due to the higher frequencies, it is inevitable that the wireless channel will be subject to higher path-loss making it more challenging to maintain an adequate quality of service that is at least equal to that of legacy RATs. The enhancements for Msg3 physical uplink share channel (PUSCH), PUSCH and physical uplink control channel (PUCCH) were proposed to be specified in 3GPP Rel-17 coverage enhancements.

Regarding “Type A PUSCH repetitions for Msg3”, a UE can request Msg3 PUSCH repetition via separate physical random access channel (PRACH) resources, e.g., separate PRACH preamble in case of shared PRACH occasions. Whether a UE would request is based on some conditions, e.g., a measured SS-RSRP (reference signal received power) threshold. If Msg3 PUSCH repetition is requested by a UE, a BS decides whether to schedule Msg3 PUSCH repetition or not. If scheduled, the BS decides the number of repetitions for Msg3 PUSCH 3 (re-)transmission.

Msg3 repetition focuses on a 4-step RACH procedure. Msg3 repetition is applicable to all cases that trigger a 4-step contention-based random access (CBRA) procedure. As defined in 3GPP TS38.300, a 4-step CBRA procedure can be triggered by multiple events. Embodiments of the present application are applicable for any of Case 1 to Case 11.
Case 1: an initial access procedure from a RRC_IDLE state. In Case 1, a cell selection or reselection procedure is performed by a UE in a RRC_IDLE state before a RACH procedure; and if the reference signal received power (RSRP) threshold is met (e.g., at a cell edge), the UE can request Msg3 repetition.
Case 2: RRC Re-establishment procedure after a RLF or a handover failure. The same as Case 1, in Case 2, if a UE fulfills the RSRP threshold (e.g., at a cell edge), the UE can request Msg3 repetition.
Case 3: DL or UL data arrival during a RRC_CONNECTED state when UL synchronization status is “non-synchronized”. In Case 3, if RSRP of a primary cell of a master or secondary cell group (SpCell) is lower than the threshold, a UE can request to enable Msg3 repetition.
Case 4: UL data arrival during a RRC_CONNECTED state when there is no PUCCH resource available for a scheduling request (SR). Similar to Case 3, in Case 4, if at the moment, the SpCell's RSRP is lower than the pre-configured threshold, then, a UE can request to enable Msg3 repetition.
Case 5: no scheduling request (SR) configuration. In Case 5, a UE is allowed to request Msg3 repetition when a RSRP threshold is fulfilled.
Case 6: performing a handover procedure.
Case 7: a transition from a RRC_INACTIVE state. The same as Case 1 and Case 2, in Case 7, if a UE fulfills the RSRP threshold (e.g., at a cell edge), the UE can request Msg3 repetition.
Case 8: to establish time alignment for a secondary timing advance group (TAG).
Case 9: a request for other system information (SI). In Case 9, the initial access procedure is the same as Case 1, and thus, Msg3 repetition is applicable as long as RSRP of a primary cell (PCell) fulfills a RSRP threshold.
Case 10: a beam failure recovery. In Case 10, Msg3 repetition can be applicable to a CBRA case.
Case 11: consistent UL listen before transmit (LBT) failure on SpCell. In Case 11, Msg3 repetition is applicable when the RSRP fulfills a RSRP threshold.

Regarding a RSRP threshold, a separate RSRP threshold may be introduced for requesting Msg3 repetition. A UE can request Msg3 PUSCH repetition only when the RSRP of the UE is lower than a configured threshold. Msg3 repetition on both normal uplink (NUL) and supplementary uplink (SUL) will be supported. A RSRP threshold for requesting Msg3 repetition is configured per uplink carrier, and different values of this threshold between NUL and SUL can be configured (details refer to 3GPP R1-2110585).

Regarding a separate rsrp-ThresholdSSB, it can be beneficial to separately configure rsrp-ThresholdSSB for requesting Msg3 PUSCH repetition with a shared RACH occasion (RO) on a given UL carrier.

Regarding separate preambles, it is feasible to support both “Group A with or without Msg3 repetition” and “Group B with or without repetition”. If supported, a separate set of Group B related parameters such as ra-Msg3SizeGroupA, messagePowerOffsetGroupB and numberOfRA-PreamblesGroupA for request of Msg3 repetition can be introduced. Using separate preambles with a shared RO may be configured by the same PRACH configuration index as legacy UEs.

As defined in 3GPP TS38.213, for indication of the number of repetitions for Msg3 initial transmission, an information field from the existing information fields in random access response (RAR) UL grant is used for indication of the number of repetition of Msg3 initial transmission. For example, one of the following will be adopted: (1) a time domain resource allocation (TDRA) information field with introducing a new TDRA table including the repetition factors; and (2) a mission critical service (MCS) information field.

For indication of the number of repetitions for Msg3 re-transmission, Option 1 (i.e., using DCI format 0_0 with CRC scrambled by TC-RNTI) is adopted. The separate preambles for requesting Msg3 repetition could be configured only in an RO configured with 4-step RACH preambles not for requesting Msg3 repetition. As defined in 3GPP TS38.213, at least repetition factor K={1, 2, 3, 4, 7, 8} for Msg3 PUSCH repetition is supported.

Regarding other RRC parameters for request of Msg3 repetition with shared RO, at least the number of preambles per SSB per RO for request of Msg3 repetition is needed. 3GPP RAN1 has no consensus on optionally configuring a separate set of RACH parameters for preambleReceivedTargetPower, powerRampingStep, preambleTransMax (as defined in 3GPP TS38.321) for requesting Msg3 repetition with shared RO. If separate RO is supported for requesting Msg3 PUSCH repetition (not supported yet and no consensus in RAN1), 3GPP RAN1 thinks that a separate set of RACH parameters can be configured.

In addition, repetition(s) of PUSCH and PUCCH is also introduced in 3GPP Rel-17 coverage enhancement (CE). For PUSCH, the repetition is configured by RRC signalling. For PUCCH, dynamic PUCCH repetition factor indication is transmitted to a UE via downlink control information (DCI).

Regarding PUSCH repetition type A, RRC configures the number of repetitions. The maximum number of repetitions is introduced for PUSCH transmission. The maximum number of repetitions supported by Rel-17 PUSCH repetition Type A is 32. The following additional value set for repetition factor is supported in Rel-17: {1, 2, 3, 4, 7, 8, 12, 16, 20, 24, 28, 32}. The number of repetitions counted on the basis of available UL slots. The procedure of Rel-17 PUSCH repetitions counted on the basis of available slots. Step 1: Determine available slots for K repetitions based on RRC configuration(s) in addition to TDRA in the DCI scheduling the PUSCH, CG configuration or activation DCI. Step 2: The UE determines whether to drop a PUSCH repetition or not according to Rel-15 or Rel-16 PUSCH dropping rules, but the PUSCH repetition is still counted in the K repetitions.

Regarding transport block (TB) processing over multi-slot PUSCH, a transport block size (TBS) can be transmitted over multiple slots. Time domain resource determination for TB processing over multi-slot (TBoMS) can be performed only via PUSCH repetition Type A. TBoMS is supported for both configured grant and dynamic grant. Number of slots allocated for TBoMS is determined by using a row index of a TDRA list, configured via RRC signalling. N allocated slots for the single TBoMS are defined as the number of slots after available slot determination for a single TBoMS transmission and before dropping rules are applied.

Regarding “a dynamic PUCCH repetition factor indication”, a dynamic PUCCH repetition factor indication is transmitted to a UE. RRC signalling is enhanced to allow configuration of PUCCH repetition factor per PUCCH resource. Rel-16 PUCCH resource indication mechanism is reused based on “PUCCH resource indicator” (PRI) field and starting CCE index (when applicable based on Rel-16 spec) of DCI to indicate a PUCCH resource and its associated repetition factor. If both a new repetition parameter corresponding to Rel-17 dynamic PUCCH repetition factor indication and the Rel-15 or Rel-16 nrofSlots are configured for a PUCCH resource, the new repetition parameter overrides nrofSlots. In Rel-17, the Rel-16 PUCCH repetition factors {2, 4, 8} are reused.

In general, network slicing is a concept to allow differentiated treatment depending on each customer requirements. With network slicing, it is possible for mobile network operators (MNO) to consider customers as belonging to different tenant types with each having different service requirements that govern in terms of what slice types each tenant is eligible to use based on Service Level Agreement (SLA) and subscriptions. A network slice always consists of a RAN part and a CN part. The support of network slicing relies on the principle that traffic for different slices is handled by different PDU sessions. A network node can realize the different network slices by scheduling and also by providing different L1 or L2 configurations. Each network slice is uniquely identified by a S-NSSAI, as defined in 3GPP TS23.501 [3]. Network Slice Selection Assistance Information (NSSAI) includes one or a list of S-NSSAIs (Single NSSAI), where a S-NSSAI is a combination of: (1) mandatory slice or service type (SST) field, which identifies the slice type and consists of 8 bits (with range is 0-255); and (2) optional slice differentiator (SD) field, which differentiates among slices with same SST field and consist of 24 bits.

A UE provides NSSAI for a network slice selection in RRCSetupComplete message, if it has been provided by non access stratum (NAS) (see 3GPP TS23.501). While the network node can support large number of slices (hundreds), the UE need not support more than 8 slices simultaneously. A bandwidth reduced low complexity (BL) UE or a narrow band internet of things (NB-IoT) UE supports a maximum of 8 slices simultaneously.

Regarding Rel-17 network slicing, RACH resources can be associated to specific slice groups. Slice-specific RACH (including RACH isolation and RACH prioritization) is only applied for CBRA. Both RO partition and preambles partition can be supported. A network node can configure slices with 4-step or 2-step (or both) RA resources. For RACH type selection, a UE firstly selects between a slice-specific RACH procedure and a common RACH procedure, and then, selects between 2-step and 4-step RACH procedures. The legacy threshold for the selection between 2-step and 4-step slice initiated RACH procedures is reused.

Fallback from 2-step slice-specific RACH procedure to 4-step common RACH procedure is used, if 4-step slice-specific RACH procedure is not configured. A maximum number of preamble for fallback from 2-step to 4-step. The following two fallback cases are not supported in Rel-17: (1) Fallback case 1: fallback from 4-step slice-specific RACH procedure to 4-step common RACH procedure; and (2) Fallback case 3: fallback from 2-step slice-specific RACH procedure to 2-step common RACH procedure, if neither 4-step slice-specific RACH procedure nor 4-step common RACH procedure is configured.

Currently, for instance, following issues are addressed: (1) in both Rel-17 CE and network slicing topic, RACH procedure, e.g., CBRA is enhanced; in legacy, a RA-report is reported by a UE to a network node for optimization purpose; and therefore, RA-report should be enhanced accordingly; and (2) a legacy RLF-report is reported by a UE to a network node for a failure optimization purpose, and the RLF-report should also be enhanced considering the enhanced RACH and repetition of PUSCH and PUCCH. Embodiments of the present application aim to solve the above-mentioned issues. Specifically, some embodiments of the present application study MRO for Rel-17 CE and RAN slicing. Some embodiments of the present application provide assistant information which is reported by a UE to a network node for an optimization purpose. More details will be illustrated in following text in combination with the appended drawings.

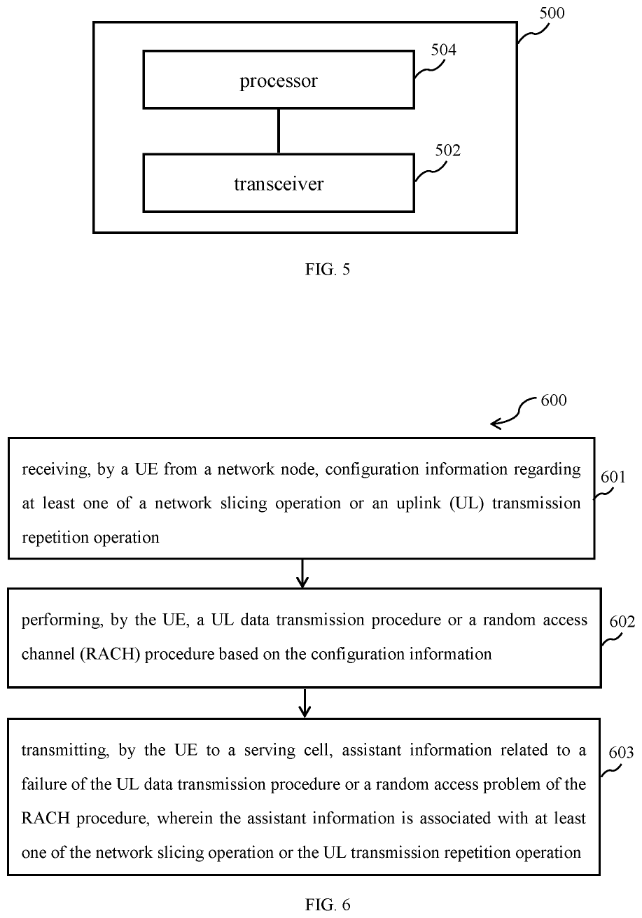

FIG. 5 illustrates an exemplary block diagram of an apparatus according to some embodiments of the present application. As shown in FIG. 5, the apparatus 500 may include at least one processor 504 and at least one transceiver 502 coupled to the processor 504. The at least one transceiver 502 may be a wired transceiver or a wireless transceiver. The apparatus 500 may be a UE or a network node (e.g., a source BS or a target BS).

Although in this figure, elements such as the at least one transceiver 502 and the processor 504 are described in the singular, the plural is contemplated unless a limitation to the singular is explicitly stated. In some embodiments of the present application, the transceiver 502 may be divided into two devices, such as a receiving circuitry and a transmitting circuitry. In some embodiments of the present application, the apparatus 500 may further include an input device, a memory, and/or other components.

In some embodiments of the present application, the apparatus 500 may be a UE (e.g., UE 101a or UE 210 as shown and illustrated in FIG. 1 or FIG. 2). The processor 504 of the UE may be configured: to receive, via the transceiver from a network node, configuration information regarding at least one of a network slicing operation or an uplink (UL) transmission repetition operation; to perform a UL data transmission procedure or a RACH procedure based on the configuration information; and to transmit, via the transceiver 502 to a serving cell, assistant information related to a failure of the UL data transmission procedure or a random access problem of the RACH procedure, wherein the assistant information is associated with at least one of the network slicing operation or the UL transmission repetition operation.

According to some embodiments, in a case that the UE is in a RRC connected state (i.e., RRC_CONNECTED state), the configuration information is received via RRC signalling. According to some other embodiments, in a case that the UE is in an idle state (i.e., an IDLE state) or an inactive state (i.e., an INACTIVE state), the configuration information is received via broadcast signalling, e.g., system information block (SIB).

In some embodiments, the assistant information is carried in at least one of a radio link failure (RLF) report or a radio access (RA) report, and the at least one of the RLF report or the RA report is included in a UE information response message (e.g., a UEInformationResponse message as described in Embodiment 1).

In some embodiments, the assistant information includes at least one of:
(1) a repetition total number of a physical uplink share channel (PUSCH) transmission;
(2) a repetition total number of the PUSCH transmission within a time duration;
(3) a repetition total number of a physical uplink control channel (PUCCH) transmission;
(4) a repetition total number of the PUCCH transmission within a time duration; or
(5) one or more slots allocated for a single transport block processing over multi-slot (TBoMS) transmission. A specific example is described in Embodiment 1 as follows.

In some other embodiments, the assistant information includes at least one of:
(1) a RSRP threshold for requesting a PUSCH repetition of Msg3;
(2) a RSRP threshold for requesting a PUSCH repetition of MsgA;
(3) a RSRP threshold for requesting the PUSCH repetition of Msg3 for a normal uplink (NUL);
(4) a RSRP threshold for requesting the PUSCH repetition of MsgA for the NUL;
(5) a RSRP threshold for requesting the PUSCH repetition of Msg3 for a supplementary uplink (SUL); or
(6) a RSRP threshold for requesting the PUSCH repetition of MsgA for the SUL. Specific examples are described in any of Embodiments 1-3 for an UL CE case as follows.

In some other embodiments, the assistant information includes at least one of:
(1) a RSRP threshold (e.g., layer 1 (L1) RSRP threshold) for determining candidate synchronization signal block (SSB) to attempt PUSCH repetition of Msg3;
(2) a RSRP threshold (e.g., L1 RSRP threshold) for determining candidate SSB to attempt PUSCH repetition of MsgA;
(3) a RSRP threshold (e.g., L1 RSRP threshold) for determining candidate SSB to attempt PUSCH repetition of Msg3 for the NUL;
(4) a RSRP threshold (e.g., L1 RSRP threshold) for determining candidate SSB to attempt PUSCH repetition of MsgA for the NUL;
(5) a RSRP threshold (e.g., L1 RSRP threshold) for determining candidate SSB to attempt PUSCH repetition of Msg3 for the SUL; or
(6) a RSRP threshold (e.g., L1 RSRP threshold) for determining candidate SSB to attempt PUSCH repetition of MsgA for the SUL. Specific examples are described in Embodiments 1-3 as follows.

In some further embodiments, the assistant information includes at least one of:
(1) information indicating whether a preamble is configured for requesting the PUSCH repetition of Msg3 for each attempt; or
(2) information indicating whether a preamble is configured for requesting the PUSCH repetition of MsgA for the each attempt. A specific example is described in Embodiment 3 as follows.

In some additional embodiments, the assistant information includes at least one of.
(1) a total number of PUSCH repetitions for Msg3 initial transmission;
(2) a total number of PUSCH repetitions for MsgA initial transmission;
(3) a total number of the PUSCH repetitions for the Msg3 initial transmission for the each attempt;
(4) a total number of the PUSCH repetitions for the MsgA initial transmission for the each attempt;
(5) a total number of PUSCH repetitions for Msg3 re-transmission;
(6) a total number of PUSCH repetitions for MsgA re-transmission;
(7) a total number of the PUSCH repetitions for the Msg3 re-transmission for the each attempt;
(8) a total number of the PUSCH repetitions for the MsgA re-transmission for the each attempt;
(9) a total number of preambles per SSB per RACH occasion (RO) for requesting the PUSCH repetition of Msg3; or
(10) a total number of preambles per SSB per RO for requesting the PUSCH repetition of MsgA. Specific examples are described in Embodiments 1-3 as follows.

In some additional embodiments, the assistant information includes at least one of.
(1) a RSRP threshold for a selection operation between a slice-specific RACH procedure and a common RACH procedure;
(2) a RSRP threshold for a selection operation between a 2-step RACH procedure and a 4-step RACH procedure;
(3) information indicating whether a preamble is configured for a specific network slicing or a specific network slicing group for each attempt;
(4) information indicating whether a fallback operation (e.g., a fall back from a 2-step slice-specific RACH procedure to a 4-step common RACH procedure) happens;
(5) a maximum number of MsgA preamble transmissions performed before switching from a 2-step slice-specific RACH procedure to a 4-step RACH procedure; or
(6) information indicating whether a reported MsgA PUSCH resource is configured for the network slicing operation or not. Specific examples are described in Embodiment 3 for network slicing as follows.

In some embodiments of the present application, the apparatus 500 may be a source network node (e.g., BS 102a, BS 310, or BS 420 as shown and illustrated in any of FIGS. 1, 3, and 4). In particular, the processor 504 of the source network node may be configured to transmit, via the transceiver 502 to a UE (e.g., UE 101a or UE 210 as shown and illustrated in FIG. 1 or FIG. 2), configuration information regarding at least one of a network slicing operation or an uplink (UL) transmission repetition operation. The processor 504 of the source network node may be configured to receive, via the transceiver 502 from a target network node (e.g., BS 102b, BS 102c, BS 320, or BS 410 as shown and illustrated in any of FIGS. 1, 3, and 4), assistant information related to a failure of a UL data transmission procedure or a random access problem of a RACH procedure. The assistant information is associated with at least one of the network slicing operation or the UL transmission repetition operation.

According to some embodiments, in a case that the UE is in a RRC connected state, the configuration information is transmitted via RRC signalling. According to some other embodiments, in a case that the UE is in an idle state or an inactive state, the configuration information is transmitted via broadcast signalling (e.g., SIB).

In some embodiments, the assistant information is carried in a message over an Xn interface (e.g., a UEInformationResponse message as described in Embodiment 1).

In some embodiments, the assistant information includes at least one of:
(1) a repetition total number of a PUSCH transmission;
(2) a repetition total number of the PUSCH transmission within a time duration;
(3) a repetition total number of a PUCCH transmission;
(4) a repetition total number of the PUCCH transmission within a time duration; or
(5) one or more slots allocated for a single TBoMS transmission. A specific example is described in Embodiment 1 as follows.

In some other embodiments, the assistant information includes at least one of:
(1) a RSRP threshold for requesting a PUSCH repetition of Msg3;
(2) a RSRP threshold for requesting a PUSCH repetition of MsgA;
(3) a RSRP threshold for requesting the PUSCH repetition of Msg3 for a NUL;
(4) a RSRP threshold for requesting the PUSCH repetition of MsgA for the NUL;
(5) a RSRP threshold for requesting the PUSCH repetition of Msg3 for a SUL; or
(6) a RSRP threshold for requesting the PUSCH repetition of MsgA for the SUL. Specific examples are described in any of Embodiments 1-3 for an UL CE case as follows.

In some other embodiments, the assistant information includes at least one of:
(1) a RSRP threshold (e.g., L1 RSRP threshold) for determining candidate SSB to attempt PUSCH repetition of Msg3;
(2) a RSRP threshold (e.g., L1 RSRP threshold) for determining candidate SSB to attempt PUSCH repetition of MsgA;
(3) a RSRP threshold (e.g., L1 RSRP threshold) for determining candidate SSB to attempt PUSCH repetition of Msg3 for the NUL;
(4) a RSRP threshold (e.g., L1 RSRP threshold) for determining candidate SSB to attempt PUSCH repetition of MsgA for the NUL;
(5) a RSRP threshold (e.g., L1 RSRP threshold) for determining candidate SSB to attempt PUSCH repetition of Msg3 for the SUL; or
(6) a RSRP threshold (e.g., L1 RSRP threshold) for determining candidate SSB to attempt PUSCH repetition of MsgA for the SUL. Specific examples are described in Embodiments 1-3 as follows.

In some further embodiments, the assistant information includes at least one of.
(1) information indicating whether a preamble is configured for requesting the PUSCH repetition of Msg3 for each attempt; or
(2) information indicating whether a preamble is configured for requesting the PUSCH repetition of MsgA for the each attempt. A specific example is described in Embodiment 3 as follows.

In some additional embodiments, the assistant information includes at least one of:
(1) a total number of PUSCH repetitions for Msg3 initial transmission;
(2) a total number of PUSCH repetitions for MsgA initial transmission;
(3) a total number of the PUSCH repetitions for the Msg3 initial transmission for the each attempt;
(4) a total number of the PUSCH repetitions for the MsgA initial transmission for the each attempt;
(5) a total number of PUSCH repetitions for Msg3 re-transmission;
(6) a total number of PUSCH repetitions for MsgA re-transmission;
(7) a total number of the PUSCH repetitions for the Msg3 re-transmission for the each attempt;
(8) a total number of the PUSCH repetitions for the MsgA re-transmission for the each attempt;
(9) a total number of preambles per SSB per RACH occasion (RO) for requesting the PUSCH repetition of Msg3; or (10)a total number of preambles per SSB per RO for requesting the PUSCH repetition of MsgA. Specific examples are described in Embodiments 1-3 as follows.

In some additional embodiments, the assistant information includes at least one of:
(1) a RSRP threshold for a selection operation between a slice-specific RACH procedure and a common RACH procedure;
(2) a RSRP threshold for a selection operation between a 2-step RACH procedure and a 4-step RACH procedure;
(3) information indicating whether a preamble is configured for a specific network slicing or a specific network slicing group for each attempt;
(4) information indicating whether a fallback operation (e.g., a fall back from a 2-step slice-specific RACH procedure to a 4-step common RACH procedure) happens;
(5) a maximum number of MsgA preamble transmissions performed before switching from a 2-step slice-specific RACH procedure to a 4-step RACH procedure; or
(6) information indicating whether a reported MsgA PUSCH resource is configured for the network slicing operation or not. Specific examples are described in Embodiment 3 for network slicing as follows.

In some embodiments of the present application, the apparatus 500 may be a target network node (e.g., BS 102b, BS 102c, BS 320, or BS 410 as shown and illustrated in any of FIGS. 1, 3, and 4). In particular, the processor 504 of the target network node may be configured to receive, via the transceiver 502 from a UE (e.g., UE 101a or UE 210 as shown and illustrated in FIG. 1 or FIG. 2), assistant information related to a failure of an UL data transmission procedure or a random access problem of a RACH procedure. The assistant information is associated with at least one of a network slicing operation or a UL transmission repetition operation. The processor 504 of the target network node may be configured to transmit the assistant information via the transceiver 502 to a source network node (e.g., BS 102a, BS 310, or BS 420 as shown and illustrated in any of FIGS. 1, 3, and 4).

According to some embodiments, the processor 504 of the target network node may be configured to transmit, via the transceiver 502 to the UE, configuration information regarding at least one of the network slicing operation or the UL transmission repetition operation. A specific example is described in Embodiment 2 as follows.

According to some embodiments, the assistant information is carried in at least one of a RLF report or a RA report. The at least one of the RLF report or the RA report may be included in a UE information response message (e.g., a UEInformationResponse message as described in Embodiment 1). The UE information response message may be received by the target network node.

In some embodiments, the assistant information includes at least one of:
(1) a repetition total number of a PUSCH transmission;
(2) a repetition total number of the PUSCH transmission within a time duration;
(3) a repetition total number of a PUCCH transmission;
(4) a repetition total number of the PUCCH transmission within a time duration; or
(5) one or more slots allocated for a single TBoMS transmission. A specific example is described in Embodiment 1 as follows.

In some other embodiments, the assistant information includes at least one of.
(1) a RSRP threshold for requesting a PUSCH repetition of Msg3;
(2) a RSRP threshold for requesting a PUSCH repetition of MsgA;
(3) a RSRP threshold for requesting the PUSCH repetition of Msg3 for a NUL;
(4) a RSRP threshold for requesting the PUSCH repetition of MsgA for the NUL;
(5) a RSRP threshold for requesting the PUSCH repetition of Msg3 for a SUL; or
(6) a RSRP threshold for requesting the PUSCH repetition of MsgA for the SUL. Specific examples are described in any of Embodiments 1-3 for an UL CE case as follows.

In some other embodiments, the assistant information includes at least one of:
(1) a RSRP threshold (e.g., L1 RSRP threshold) for determining candidate SSB to attempt PUSCH repetition of Msg3;
(2) a RSRP threshold (e.g., L1 RSRP threshold) for determining candidate SSB to attempt PUSCH repetition of MsgA;
(3) a RSRP threshold (e.g., L1 RSRP threshold) for determining candidate SSB to attempt PUSCH repetition of Msg3 for the NUL;
(4) a RSRP threshold (e.g., L1 RSRP threshold) for determining candidate SSB to attempt PUSCH repetition of MsgA for the NUL;
(5) a RSRP threshold (e.g., L1 RSRP threshold) for determining candidate SSB to attempt PUSCH repetition of Msg3 for the SUL; or
(6) a RSRP threshold (e.g., L1 RSRP threshold) for determining candidate SSB to attempt PUSCH repetition of MsgA for the SUL. Specific examples are described in Embodiments 1-3 as follows.

In some further embodiments, the assistant information includes at least one of:
(1) information indicating whether a preamble is configured for requesting the PUSCH repetition of Msg3 for each attempt; or
(2) information indicating whether a preamble is configured for requesting the PUSCH repetition of MsgA for the each attempt. A specific example is described in Embodiment 3 as follows.

In some additional embodiments, the assistant information includes at least one of:
(1) a total number of PUSCH repetitions for Msg3 initial transmission;
(2) a total number of PUSCH repetitions for MsgA initial transmission;
(3) a total number of the PUSCH repetitions for the Msg3 initial transmission for the each attempt;
(4) a total number of the PUSCH repetitions for the MsgA initial transmission for the each attempt;
(5) a total number of PUSCH repetitions for Msg3 re-transmission;
(6) a total number of PUSCH repetitions for MsgA re-transmission;
(7) a total number of the PUSCH repetitions for the Msg3 re-transmission for the each attempt;
(8) a total number of the PUSCH repetitions for the MsgA re-transmission for the each attempt;
(9) a total number of preambles per SSB per RO for requesting the PUSCH repetition of Msg3; or (10)a total number of preambles per SSB per RO for requesting the PUSCH repetition of MsgA. Specific examples are described in Embodiments 1-3 as follows.

In some additional embodiments, the assistant information includes at least one of:
(1) a RSRP threshold for a selection operation between a slice-specific RACH procedure and a common RACH procedure;
(2) a RSRP threshold for a selection operation between a 2-step RACH procedure and a 4-step RACH procedure;
(3) information indicating whether a preamble is configured for a specific network slicing or a specific network slicing group for each attempt;
(4) information indicating whether a fallback operation (e.g., a fall back from a 2-step slice-specific RACH procedure to a 4-step common RACH procedure) happens;
(5) a maximum number of MsgA preamble transmissions performed before switching from a 2-step slice-specific RACH procedure to a 4-step RACH procedure; or
(6) information indicating whether a reported MsgA PUSCH resource is configured for the network slicing operation or not. Specific examples are described in Embodiment 3 for network slicing as follows.

In some embodiments of the present application, the apparatus 200 may include at least one non-transitory computer-readable medium. In some embodiments of the present disclosure, the non-transitory computer-readable medium may have stored thereon computer-executable instructions to cause a processor to implement the method with respect to a UE or a network node (e.g., a source BS or a target BS) as described above. For example, the computer-executable instructions, when executed, cause the processor 504 interacting with the transceiver 502, so as to perform operations of the methods, e.g., as described in view of FIGS. 6-8.

FIG. 6 illustrates an exemplary flow chart of a method for transmitting assistant information according to some embodiments of the present application. The method 600 may be performed by a UE (e.g., UE 101a or UE 210 as shown and illustrated in FIG. 1 or FIG. 2). Although described with respect to a UE, it should be understood that other devices may also be configured to perform the method as shown and illustrated in FIG. 6.

In the exemplary method 600 as shown in FIG. 6, in operation 601, a UE (e.g., UE 101a as shown and illustrated in FIG. 1) receives, from a network node, configuration information regarding at least one of a network slicing operation or an UL transmission repetition operation. In operation 602, the UE performs a UL data transmission procedure or a RACH procedure based on the configuration information. In operation 603, the UE transmits, to a serving cell, assistant information related to a failure of the UL data transmission procedure or a random access problem of the RACH procedure. The assistant information is associated with at least one of the network slicing operation or the UL transmission repetition operation.

It is contemplated that the method illustrated in FIG. 6 may include other operation(s) not shown, for example, any operation(s) described with respect to any of FIGS. 5, 7, and 8 and Embodiments 1-3.

Details described in all other embodiments of the present application (for example, details regarding a MRO mechanism for UL CE and/or network slicing procedures) are applicable for the embodiments of FIG. 6. Moreover, details described in the embodiments of FIG. 6 are applicable for all embodiments of FIGS. 1-5, 7, and 8. It should be appreciated by persons skilled in the art that the sequence of the operations in exemplary procedure in the embodiments of FIG. 6 may be changed and some of the operations in exemplary procedure in the embodiments of FIG. 6 may be eliminated or modified, without departing from the spirit and scope of the disclosure.

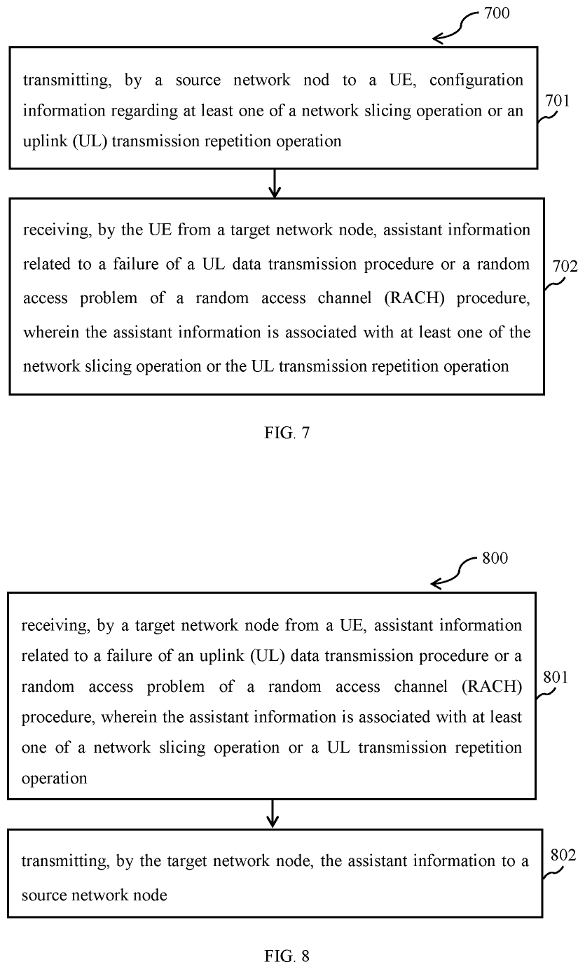

FIG. 7 illustrates an exemplary flow chart of a method for receiving assistant information according to some embodiments of the present application. The embodiments of FIG. 7 may be performed by a source network node (e.g., BS 102a, BS 310, or BS 420 as shown and illustrated in any of FIGS. 1, 3, and 4). Although described with respect to a source network node, it should be understood that other devices may be configured to perform a method similar to that of FIG. 7.

In the exemplary method 700 as shown in FIG. 7, in operation 701, a source network node (e.g., BS 102a, BS 310, or BS 420 as shown and illustrated in any of FIGS. 1, 3, and 4) transmits, to a UE (e.g., UE 101a or UE 210 as shown and illustrated in FIG. 1 or FIG. 2), configuration information regarding at least one of a network slicing operation or an UL transmission repetition operation. In operation 702 as shown in FIG. 7, the source network node receives, from a target network node (e.g., BS 102b, BS 102c, BS 320, or BS 410 as shown and illustrated in any of FIGS. 1, 3, and 4), assistant information related to a failure of a UL data transmission procedure or a random access problem of a RACH procedure. The assistant information is associated with at least one of the network slicing operation or the UL transmission repetition operation.

It is contemplated that the method illustrated in FIG. 7 may include other operation(s) not shown, for example, any operation(s) described with respect to any of FIGS. 5, 6, and 8 and Embodiments 1-3.

Details described in all other embodiments of the present application (for example, details regarding a MRO mechanism for UL CE and/or network slicing procedures) are applicable for the embodiments of FIG. 7. Moreover, details described in the embodiments of FIG. 7 are applicable for all embodiments of FIGS. 1-6 and 8. It should be appreciated by persons skilled in the art that the sequence of the operations in exemplary procedure in the embodiments of FIG. 7 may be changed and some of the operations in exemplary procedure in the embodiments of FIG. 7 may be eliminated or modified, without departing from the spirit and scope of the disclosure.

FIG. 8 illustrates a further exemplary flow chart of receiving assistant information according to some embodiments of the present application. The embodiments of FIG. 8 may be performed by a target network node (e.g., BS 102b, BS 102c, BS 320, or BS 410 as shown and illustrated in any of FIGS. 1, 3, and 4). Although described with respect to a target network node, it should be understood that other devices may be configured to perform a method similar to that of FIG. 8.

In the exemplary method 800 as shown in FIG. 8, in operation 801, a target network node (e.g., BS 102b, BS 102c, BS 320, or BS 410 as shown and illustrated in any of FIGS. 1, 3, and 4) receives, from a UE (e.g., UE 101a or UE 210 as shown and illustrated in FIG. 1 or FIG. 2) assistant information related to a failure of an uplink (UL) data transmission procedure or a random access problem of a random access channel (RACH) procedure. The assistant information is associated with at least one of a network slicing operation or a UL transmission repetition operation. In operation 802 as shown in FIG. 8, the target network node transmits the assistant information to a source network node (e.g., BS 102a, BS 310, or BS 420 as shown and illustrated in any of FIGS. 1, 3, and 4).

It is contemplated that the method illustrated in FIG. 8 may include other operation(s) not shown, for example, any operation(s) described with respect to any of FIGS. 5-7 and Embodiments 1-3.

Details described in all other embodiments of the present application (for example, details regarding a MRO mechanism for UL CE and/or network slicing procedures) are applicable for the embodiments of FIG. 8. Moreover, details described in the embodiments of FIG. 8 are applicable for all embodiments of FIGS. 1-7. It should be appreciated by persons skilled in the art that the sequence of the operations in exemplary procedure in the embodiments of FIG. 8 may be changed and some of the operations in exemplary procedure in the embodiments of FIG. 8 may be eliminated or modified, without departing from the spirit and scope of the disclosure.

The following texts describe specific Embodiments 1-3 of the methods as shown and illustrated in FIGS. 3-5. According to Embodiments 1-3, a UE and a network node (a source BS and/or a target BS) perform following operations. The UE may be UE 101a or UE 210 as shown and illustrated in FIG. 1 or FIG. 2. The network node may be BS 102a, BS 102b, BS 102c, BS 310, BS 320, BS 410, or BS 420 as shown and illustrated in any of FIGS. 1-4.

### Embodiment 1

Embodiment 1 refers to a scenario in which a RLF happens for a UE in a RRC_CONNECTED state in an UL CE case. In particular, in Embodiment 1, following steps may be performed.
(1) Step 1: A UE is in a RRC_CONNECTED state. A source BS transmits the configuration to the UE. The configuration could include at least one of following parameters:
   a) The configuration could include: measurement configuration, the repetition number of PUSCH, and/or configuration of PUCCH repetition factor per PUCCH resource.
   b) A RSRP threshold for requesting Msg3 repetition for NUL and/or SUL.
   c) SSB RSRP threshold for requesting Msg3 PUSCH repetition for NUL and/or SUL.
   d) A total number of repetitions for Msg3 initial transmission.
   e) A total number of preambles per SSB per RO for request of Msg3 repetition.
   f) Both Group A with or without Msg3 repetition and Group B with or without repetition. A separate set of Group B related parameters, such as ra-Msg3SizeGroupA, messagePowerOffsetGroupB and numberOfRA-PreamblesGroupA, for request of Msg3 repetition can be configured.
(2) Step 2: The UE will transmit PUSCH and/or PUCCH transmission(s).
   a) When the UE transmits the PUCCH transmission, DCI will indicate a PUCCH resource and its associated repetition factor.
   b) When the UE transmits the PUSCH transmission, the repetition number of PUSCH configured by RRC signaling can be applied.
(3) Step 3: The UE declares a RLF.
   a) The cause of the RLF could be one of: Timer T310-Expiry, a random access problem, a maximum re-transmission number in RLC layer, and a beam failure recovery failure.
(4) Step 4: The UE initiates a re-establishment procedure and performs a cell selection procedure.
(5) Step 5: The UE transmits RRCReestalishmentRequest message to the selected suitable cell. After successfully re-establishing to one suitable cell, the UE transmits the indication of radio link failure information available or random access problem information available to the serving cell.
(6) Step 6: A target BS (e.g., a target gNB) transmits UEInformationRequest message to the UE after receiving the indication from the UE.
   a) The UEInformationRequest message may include a RLF-report request and/or a RA-report request.
(7) Step 7: The UE transmits UEInformationResponse message to the target BS. At least one of following information may be included in the UEInformationResponse message.
   a) In a case that the UEInformationResponse message includes a RLF-report, the RLF-report could include:
      1) a total repetition number of PUSCH;
      2) a total repetition number of PUSCH within a time duration, e.g., a time duration before a RLF happens.
      3) a total repetition number of PUCCH;
      4) a total repetition number of PUCCH within a time duration, e.g., a time duration before a RLF happens; and/or
      5) the allocated slots for the single TBoMS.
   b) In a case that the cause of RLF is a maximum retransmission number in RLC layer, a repetition number may be configured to two or more.
   c) In a case that the UEInformationResponse message includes a RLF-report and a RA-report, at least one of following information could be included in the RLF-report and the RA-report.
      1) A RSRP threshold for requesting repetition, e.g., Msg3 or MsgA. A UE can request Msg3 PUSCH repetition only when the RSRP of the UE is lower than a configured RSRP threshold.
      2) A RSRP threshold for requesting repetition for NUL, e.g., Msg3 or MsgA. A UE can request Msg3 PUSCH repetition only when the RSRP of the UE is lower than a configured RSRP threshold for NUL.
      3) A RSRP threshold for requesting repetition for SUL, e.g., Msg3 or MsgA. A UE can request Msg3 PUSCH repetition only when the RSRP of the UE is lower than a configured RSRP threshold for SUL.
      4) A SSB RSRP threshold for requesting Msg3 PUSCH repetition.
         For instance, a L1-RSRP threshold may be used for determining whether a candidate beam could be used by the UE to attempt contention free random access for Msg3 PUSCH repetition.
         The different SSB RSRP threshold can be configured for NUL and SUL, respectively.
      5) Information indicating whether the preamble is configured for requesting Msg3 PUSCH repetition for each attempt.
      6) A total number of repetitions for Msg3 initial transmission.
      7) A total number of repetitions for Msg3 initial transmission for each attempt.
      8) A total number of repetitions for Msg3 re-transmission.
      9) A total number of repetitions for Msg3 re-transmission for each attempt.
      10) A total number of preambles per SSB per RO for request of Msg3 repetition.
(8) Step 8: After the target BS receives the report message from the UE, the target BS will transmit one Xn message (e.g., a failure indication message or a new Xn message) to the source BS.
   a) The report message reported by the UE may be transmitted as a container.

### Embodiment 2

Embodiment 2 refers to a scenario in which a handover failure happens for a UE in a RRC_CONNECTED state in an UL CE case. In particular, in Embodiment 2, following steps may be performed.
(1) Step 1: A UE is in a RRC_CONNECTED state. A source BS transmits the configuration to the UE.
(2) Step 2: The UE will transmit PUSCH and/or PUCCH transmission(s). Also, the UE will report the measurement result.
   a) When the UE transmits the PUCCH transmission, DCI will indicate a PUCCH resource and its associated repetition factor.
(3) Step 3: The source BS decides to handover the UE to a neighbor cell based on the measurement result. The source BS transmits the handover request to a target BS. The target BS transmits acknowledgement information to the source BS. The source BS transmits a handover command to the UE. The reconfiguration information from the target BS may include at least one of following parameters.
   a) The configuration could include: measurement configuration, the repetition number of PUSCH, and/or configuration of PUCCH repetition factor per PUCCH resource.
   b) A RSRP threshold for requesting Msg3 repetition for NUL and/or SUL.
   c) A SSB RSRP threshold for requesting Msg3 PUSCH repetition for NUL and/or SUL.
   d) A total number of repetitions for Msg3 initial transmission.
   e) A total number of preambles per SSB per RO for request of Msg3 repetition
   f) Both Group A with or without Msg3 repetition and Group B with or without repetition. A separate set of Group B related parameters, such as ra-Msg3SizeGroupA, messagePowerOffsetGroupB and numberOfRA-PreamblesGroupA, for request of Msg3 repetition can be configured.
(4) Step 4: The UE performs random access after the UE receives the handover command.
(5) Step 5: The UE fails to access the target cell, e.g., due to Timer T304 expiry.
(6) Step 6: The UE initiates a re-establishment procedure and performs a cell selection procedure.
(7) Step 7: The UE transmits RRCReestalishmentRequest message to the selected suitable cell. After successfully re-establishing to one suitable cell, the UE transmits the indication of radio link failure information available or random access problem information available to the serving cell.
(8) Step 8: A target BS (target BS) transmits UEInformationRequest message to the UE after receiving the indication from the UE.
   a) The UEInformationRequest message may include a RLF-report request and/or a RA-report request.
(9) Step 9: The UE transmits UEInformationResponse message to the target BS. At least one of following information may be included in the UEInformationResponse message.
   a) In a case that the UEInformationResponse message includes a RLF-report, the RLF-report could include:
      1) a total repetition number of PUSCH;
      2) a total repetition number of PUSCH within a time duration, e.g., a time duration before a RLF happens;
      3) a total repetition number of PUCCH;
      4) a total repetition number of PUCCH within a time duration, e.g., a time duration before a RLF happens; and/or
      5) the allocated slots for the single TBoMS.
   b) In a case that the cause of RLF is a maximum retransmission number in RLC layer, a repetition number may be configured to two or more.
   c) In a case that the UEInformationResponse message includes a RLF-report and a RA-report, at least one of following information could be included in the RLF-report and the RA-report.
      1) A RSRP threshold for requesting Msg3 repetition. The UE can request Msg3 PUSCH repetition only when the RSRP of the UE is lower than a configured threshold.
      2) A RSRP threshold for requesting Msg3 repetition for NUL. The UE can request Msg3 PUSCH repetition only when the RSRP of the UE is lower than a configured threshold for NUL.
      3) A RSRP threshold for requesting Msg3 repetition for SUL. The UE can request Msg3 PUSCH repetition only when the RSRP of the UE is lower than a configured threshold for SUL.
      4) A SSB RSRP threshold for requesting Msg3 PUSCH repetition.
         For instance, a L1-RSRP threshold may be used for determining whether a candidate beam could be used by the UE to attempt contention free random access for Msg3 PUSCH repetition.
         The different SSB RSRP threshold can be configured for NUL and SUL, respectively.
      5) Information indicating whether the preamble is configured for requesting Msg3 PUSCH repetition for each attempt.
      6) A total number of repetitions for Msg3 initial transmission.
      7) A total number of repetitions for Msg3 re-transmission.
      8) A total number of preambles per SSB per RO for request of Msg3 repetition.
(10) Step 10: After the target BS receives the report message from the UE, the target BS will transmit one Xn message (e.g., a failure indication message or a new Xn message) to the source BS.
   a) The report message reported by the UE may be transmitted as a container.

### Embodiment 3

Embodiment 3 refers to a scenario in which a UE in an IDLE or INACTIVE state transits to a RRC_CONNECTED state via a radio access (RA) procedure. In particular, in Embodiment 3, following steps may be performed.
(1) Step 1: A UE is an IDLE state or an INACTIVE state. A source BS transmits the configuration to the UE. The configuration could be transmitted via broadcast signalling, e.g., SIB. The configuration could include at least one of following parameters.
   a) In an UL CE case, the configuration could include at least one of:
      1) A RSRP threshold for requesting Msg3 repetition for NUL and/or SUL.
      2) A SSB RSRP threshold for requesting Msg3 PUSCH repetition for NUL and/or SUL.
      3) A total number of repetitions for Msg3 initial transmission.
   b) In a network slicing case, the configuration could include at least one of:
      1) Configuration for a slice-specific RACH procedure, e.g., a specific time-frequency resource and a specific preamble.
      2) The network node can configure network slices with 4-step or 2-step (or both) RA resources. For a network slice group, separated RO and/or separate preamble can be configured within the existing RACH-ConfigCommon and RACH-ConfigCommonTwoStepRA.
      3) A RSRP threshold for RACH type selection between a slice-specific RACH procedure and a common RACH procedure.
      4) A RSRP threshold for selection between 2-step and 4-step RACH procedures.
(2) Step 2: The UE performs random access for transient from the IDLE or INACTIVE state to a RRC_CONNECTED state.
(3) Step 3: The UE transmits an establishment complete message or a reconfiguration complete message to the serving cell after successfully transiting to the RRC_CONNECTED state.
   a) The indication of random access problem information available may be included in the establishment complete message or the reconfiguration complete message.
(4) Step 4: A target BS (e.g., a target gNB) transmits UEInformationRequest message to the UE after receiving the indication from the UE.
   a) The UEInformationRequest message may include a RA-report request.
(5) Step 5: The UE transmits UEInformationResponse message to the target BS. At least one of following information is included in the UEInformationResponse message.
   a) For an UL CE case, if the UEInformationResponse message includes a RA-report, the RA-report could include:
      1) A RSRP threshold for requesting Msg3 repetition. A UE can request Msg3 PUSCH repetition only when the RSRP of the UE is lower than a configured RSRP threshold.
      2) A RSRP threshold for requesting Msg3 repetition for NUL. A UE can request Msg3 PUSCH repetition only when the RSRP of the UE is lower than a configured RSRP threshold for NUL.
      3) A RSRP threshold for requesting Msg3 repetition for SUL. A UE can request Msg3 PUSCH repetition only when the RSRP of the UE is lower than a configured RSRP threshold for SUL.
      4) A SSB RSRP threshold for requesting Msg3 PUSCH repetition.
         For instance, a L1-RSRP threshold may be used for determining whether a candidate beam could be used by the UE to attempt contention free random access for Msg3 PUSCH repetition.
         The different SSB RSRP threshold can be configured for NUL and SUL, respectively.
      5) Information indicating whether the preamble is configured for requesting Msg3 PUSCH repetition for each attempt.
      6) A total number of repetitions for Msg3 initial transmission.
      7) A total number of repetitions for Msg3 re-transmission.
      8) A total number of preambles per SSB per RO for request of Msg3 repetition.
   b) For a network slicing case, if the UEInformationResponse message includes a RA-report, the RA-report could include:
      1) A RSRP threshold for RACH type selection between a slice-specific RACH procedure and a common RACH procedure.
      2) A RSRP threshold for selection between 2-step and 4-step RACH procedures.
      3) Information indicating whether the preamble is configured for a specific network slicing or a specific network slicing group for each attempt.
      4) Information indicating whether fallback happens, e.g., from 2-step slice-specific RACH procedure to a 4-step common RACH procedure.
      5) A maximum number of MsgA preamble transmissions performed before switching from a 2-step slice-specific RACH procedure to a 4-step RACH procedure (if fallback from a 2-step slice-specific RACH procedure to a 2-step common RACH procedure can be supported).
      6) Information indicating whether the MsgA PUSCH resource is configured for network slicing or not (if MsgA PUSCH is reported, e.g., in ra-informationcommon information element (IE) included in the RLF-report and the RA-report).
(6) Step 6: After the target BS receives the report message from the UE, the target BS will transmit one Xn message ((e.g., a failure indication message or a new Xn message) to the source BS.
   a) The report message reported by the UE is transmitted as a container.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.

1. A user equipment (UE), comprising:
at least one memory; and
at least one processor coupled with the at least one memory and configured to cause the UE to:
receive, from a network node, configuration information regarding at least one of a network slicing operation or an uplink (UL) transmission repetition operation;
perform a UL data transmission procedure or a random access channel (RACH) procedure based on the configuration information; and
transmit, to a serving cell, assistant information related to a failure of the UL data transmission procedure or a random access problem of the RACH procedure, wherein the assistant information is associated with at least one of the network slicing operation or the UL transmission repetition operation.

2. The UE of claim 1, wherein:
in response to the UE being in a radio resource control (RRC) connected state, the configuration information is received via RRC signalling; or
in response to the UE being in an idle state or an inactive state, the configuration information is received via broadcast signalling.

3. The UE of claim 1, wherein the assistant information is carried in at least one of a radio link failure (RLF) report or a radio access (RA) report, and wherein the at least one of the RLF report or the RA report is included in a UE information response message.

4. The UE of claim 1, wherein the assistant information includes at least one of:
a repetition total number of a physical uplink share channel (PUSCH) transmission;
a repetition total number of the PUSCH transmission within a time duration;
a repetition total number of a physical uplink control channel (PUCCH) transmission;
a repetition total number of the PUCCH transmission within a time duration; or
one or more slots allocated for a single transport block processing over multi-slot (TBoMS) transmission.

5. The UE of claim 1, wherein the assistant information includes at least one of:
a reference signal received power (RSRP) threshold for requesting a PUSCH repetition of Msg3;
a RSRP threshold for requesting a PUSCH repetition of MsgA;
a RSRP threshold for requesting the PUSCH repetition of Msg3 for a normal uplink (NTUL);
a RSRP threshold for requesting the PUSCH repetition of MsgA for the NUL;
a RSRP threshold for requesting the PUSCH repetition of Msg3 for a supplementary uplink (SUL); or
a RSRP threshold for requesting the PUSCH repetition of MsgA for the SUL.

6. The UE of claim 1, wherein the assistant information includes at least one of:
a RSRP threshold for determining candidate synchronization signal block (SSB) to attempt PUSCH repetition of Msg3;
a RSRP threshold for determining candidate SSB to attempt PUSCH repetition of MsgA;
a RSRP threshold for determining candidate SSB to attempt PUSCH repetition of Msg3 for a normal uplink (NUL);
a RSRP threshold for determining candidate SSB to attempt PUSCH repetition of MsgA for the NUL;
a RSRP threshold for determining candidate SSB to attempt PUSCH repetition of Msg3 for a supplementary uplink (SUL); or
a RSRP threshold for determining candidate SSB to attempt PUSCH repetition of MsgA for the SUL.

7. The UE of claim 1, wherein the assistant information includes at least one of:
information indicating whether a preamble is configured for requesting a PUSCH repetition of Msg3 for each attempt; or
information indicating whether a preamble is configured for requesting the PUSCH repetition of MsgA for the each attempt.

8. The UE of claim 1, wherein the assistant information includes at least one of:
a total number of PUSCH repetitions for Msg3 initial transmission;
a total number of PUSCH repetitions for MsgA initial transmission;
a total number of the PUSCH repetitions for the Msg3 initial transmission for each attempt;
a total number of the PUSCH repetitions for the MsgA initial transmission for the each attempt;
a total number of PUSCH repetitions for Msg3 re-transmission;
a total number of PUSCH repetitions for MsgA re-transmission;
a total number of the PUSCH repetitions for the Msg3 re-transmission for the each attempt;
a total number of the PUSCH repetitions for the MsgA re-transmission for the each attempt;
a total number of preambles per SSB per RACH occasion (RO) for requesting the PUSCH repetition of Msg3; or
a total number of preambles per SSB per RO for requesting the PUSCH repetition of MsgA.

9. The UE of claim 1, wherein the assistant information includes at least one of:
a RSRP threshold for a selection operation between a slice-specific RACH procedure and a common RACH procedure;
a RSRP threshold for a selection operation between a 2-step RACH procedure and a 4-step RACH procedure;
information indicating whether a preamble is configured for a specific slicing or a specific slicing group for each attempt;
information indicating whether a fallback operation happens;
a maximum number of MsgA preamble transmissions performed before switching from a 2-step slice specific RACH procedure to a 4-step RACH procedure;
or information indicating whether a reported MsgA PUSCH resource is configured for the network slicing operation or not.

10. An apparatus for performing a network function, the apparatus comprising:
at least one memory; and
at least one processor coupled with the at least one memory and configured to cause the apparatus to:
transmit, to a user equipment (UE), configuration information regarding at least one of a network slicing operation or an uplink (UL) transmission repetition operation; and
receive, from a target network node, assistant information related to a failure of a UL data transmission procedure or a random access problem of a random access channel (RACH) procedure, wherein the assistant information is associated with at least one of the network slicing operation or the UL transmission repetition operation.

11. The apparatus of claim 10, wherein:
in response to the UE being in a radio resource control (RRC) connected state, the configuration information is transmitted via RRC signalling; or
in response to the UE being in an idle state or an inactive state, the configuration information is transmitted via broadcast signalling.

12. The apparatus of claim 10, wherein the assistant information is carried in a message over an Xn interface.

13. The apparatus of claim 10, wherein the assistant information includes at least one of:
a repetition total number of a physical uplink share channel (PUSCH) transmission;
a repetition total number of the PUSCH transmission within a time duration;
a repetition total number of a physical uplink control channel (PUCCH) transmission;
a repetition total number of the PUCCH transmission within a time duration; or
one or more slots allocated for a single transport block processing over multi-slot (TBoMS) transmission;

14. The apparatus of claim 10, wherein the assistant information includes at least one of:
a reference signal received power (RSRP) threshold for requesting a PUSCH repetition of Msg3;
a RSRP threshold for requesting a PUSCH repetition of MsgA;
a RSRP threshold for requesting the PUSCH repetition of Msg3 for a normal uplink (NTUL);
a RSRP threshold for requesting the PUSCH repetition of MsgA for the NUL;
a RSRP threshold for requesting the PUSCH repetition of Msg3 for a supplementary uplink (SUL); or
a RSRP threshold for requesting the PUSCH repetition of MsgA for the SUL.

15. The apparatus of claim 10, wherein the assistant information includes at least one of:
a RSRP threshold for determining candidate synchronization signal block (SSB) to attempt PUSCH repetition of Msg3;
a RSRP threshold for determining candidate SSB to attempt PUSCH repetition of MsgA;
a RSRP threshold for determining candidate SSB to attempt PUSCH repetition of Msg3 for a normal uplink (NUL);
a RSRP threshold for determining candidate SSB to attempt PUSCH repetition of MsgA for the NUL;
a RSRP threshold for determining candidate SSB to attempt PUSCH repetition of Msg3 for a supplementary uplink (SUL); or
a RSRP threshold for determining candidate SSB to attempt PUSCH repetition of MsgA for the SUL.

16. An apparatus for performing a network function, the apparatus comprising:
at least one memory; and
at least one processor coupled with the at least one memory and configured to cause the apparatus to:
receive, from a user equipment (UE), assistant information related to a failure of an uplink (UL) data transmission procedure or a random access problem of a random access channel (RACH) procedure, wherein the assistant information is associated with at least one of a network slicing operation or a UL transmission repetition operation; and
transmit the assistant information to a source network node.

17. The apparatus of claim 16, wherein the at least one processor is configured to cause the apparatus to transmit, to the UE, configuration information regarding at least one of the network slicing operation or the UL transmission repetition operation.

18. The apparatus of claim 16, wherein the assistant information is carried in at least one of a radio link failure (RLF) report or a radio access (RA) report, wherein the at least one of the RLF report or the RA report is included in a UE information response message, and wherein the UE information response message is received by the apparatus.

19. The apparatus of claim 16, wherein the assistant information includes at least one of:
a repetition total number of a physical uplink share channel (PUSCH) transmission;
a repetition total number of the PUSCH transmission within a time duration;
a repetition total number of a physical uplink control channel (PUCCH) transmission;
a repetition total number of the PUCCH transmission within a time duration; or
one or more slots allocated for a single transport block processing over multi-slot (TBoMS) transmission.

20. The apparatus of claim 16, wherein the assistant information includes at least one of:
a reference signal received power (RSRP) threshold for requesting a PUSCH repetition of Msg3;
a RSRP threshold for requesting a PUSCH repetition of MsgA;
a RSRP threshold for requesting the PUSCH repetition of Msg3 for a normal uplink (NTUL);
a RSRP threshold for requesting the PUSCH repetition of MsgA for the NUL;
a RSRP threshold for requesting the PUSCH repetition of Msg3 for a supplementary uplink (SUL); or
a RSRP threshold for requesting the PUSCH repetition of MsgA for the SUL.
